(19) United States
(12) Patent Application Publication
(10) Pub. No.: US 2014/0193286 A1
(43) Pub. Date: Jul. 10, 2014

(54) METHOD AND TREATMENT ELEMENT BLANK FOR THE PRODUCTION OF A TREATMENT ELEMENT FOR A SCREW MACHINE

(71) Applicants: Dietmar John, Freiberg (DE); Dirk Kyrion, Sternenfels (DE); Karl-Conrad Polzer, Schorndorf (DE); Peter Munkes, Stuttgart (DE); Reinhard Wuttke, Remshalden (DE)

(72) Inventors: Dietmar John, Freiberg (DE); Dirk Kyrion, Sternenfels (DE); Karl-Conrad Polzer, Schorndorf (DE); Peter Munkes, Stuttgart (DE); Reinhard Wuttke, Remshalden (DE)

(21) Appl. No.: 14/236,457

(22) PCT Filed: Jul. 31, 2012
(86) PCT No.: PCT/EP2012/064932

§ 371 Date: Jan. 31, 2014

(30) Foreign Application Priority Data
Aug. 1, 2011 (DE) 10 2011 080 255.8

(51) Int. Cl. B01F 7/00

(52) U.S. Cl. CPC B01F 7/00041
USPC 419/8; 428/553

(57) ABSTRACT

In a method for the production of a treatment element for a screw machine, a treatment element core of a first metal material is arranged in an inner space of a capsule of a hot isostatic pressing installation so that a contoured annular space is formed between a capsule wall and a treatment element core. The annular space is filled with a powder of a second metal material so as to produce an anti-wear layer. Afterwards, the treatment element blank is produced in such a way that the materials are combined by hot isostatic pressing to form a composite body. The treatment element blank is then post-processed to form the treatment element. The method according to the invention simplifies the production of treatment elements by in particular simplifying post machining and/or heat treatment of the anti-wear layer thus produced.

### CROSS REFERENCE TO RELATED APPLICATIONS

This application is a United States National Phase application of International Application PCT/EP2012/064932 filed Jul. 31, 2012 and claims the benefit of priority under 35 U.S.C. §119 of German patent application DE 10 2011 080 225.8 filed Aug. 1, 2011, the entire contents of which are incorporated herein by reference.

### FIELD OF THE INVENTION

The invention relates to a method for the production of a treatment element, in particular a screw and/or kneading element for a screw machine. The invention further relates to a treatment element blank for the production of a treatment element, in particular a screw and/or kneading element for a screw machine, comprising a treatment element core of a first metal material and an anti-wear layer of a second metal material surrounding the treatment element core, wherein the second material is combined with the first material by hot isostatic pressing to form a composite body.

### BACKGROUND OF THE INVENTION

A method for the production of a screw shaft by hot isostatic pressing is known from DE 43 28 160 A1. In order to produce the screw shaft or the screw element, a steel core and a sleeve of a corrosion-resistant and wear-resistant material disposed around said steel core are arranged in a pressing mold in such a way that a slot-like annular space having a constant slot thickness is formed between the sleeve and the inside of the pressing mold. Afterwards a metal powder is introduced in the annular gap and then compressed to form a screw flight front layer. The screw flight front layer is formed by hot isostatic pressing in such a way that it forms one piece with the sleeve and the sleeve forms one piece with the steel core. The blank produced by hot isostatic pressing has three hollow-cylindrical interconnected layers of a constant thickness and is machined after cooling in such a way that the screw flight and the screw flight front layer connected thereto are produced. Since the sleeve is at first relatively soft for machining, the screw element produced after machining is furthermore subjected to heat treatment. The drawback of this method is that the described production method requires a great amount of effort. In particular when the heat treatment is performed, attention must be paid to internal stresses in the screw element to reduce or prevent the formation of stress cracks after heat treatment.

### SUMMARY OF THE INVENTION

It is an object of the invention to provide a simpler method for the production of a treatment element for a screw machine.

This object is achieved by a method for the production of a treatment element for a screw machine, the method comprising the following steps:
providing a capsule having a central longitudinal axis and a capsule wall defining an inner space;
arranging a treatment element core of a first metal material in the inner space in such a way that
   an annular space is formed between the capsule wall and the treatment element core and
   the annular space is provided with a contour along the central longitudinal axis;
filling the annular space with a powder of a second metal material so as to form an anti-wear layer;
producing a treatment element blank in such a way that a composite body is produced from the materials by hot isostatic pressing; and
post-processing the treatment element blank to obtain the treatment element.

It was found according to the invention that the production or reproduction of a treatment element is much simpler if the annular space formed between the capsule wall and the treatment element core is contoured along the central longitudinal axis or in a sectional plane extending through the central longitudinal axis so as to be adapted to an outer contour of the treatment element to be formed. Since the second material is used for forming an anti-wear layer of the treatment element, said material is a high-alloy and extremely wear-resistant and/or corrosion-resistant material which is correspondingly expensive. Because of the contoured design of the annular space, an anti-wear layer adapted to the outer contour of the treatment element to be formed is already produced during hot isostatic pressing, which reduces both the volume and the amount of material required for the second material and simplifies post-processing of the treatment element blank produced by hot isostatic pressing, in particular facilitating the machining processes for producing the outer contour of the treatment element and/or the heat treatment of the anti-wear layer which is required depending on the subsequent use. The treatment element may be a screw and/or a kneading element. The treatment element core arranged in the capsule may be formed of a solid material or it may be provided with a through-hole.

Since the anti-wear layer according to the production method disclosed in DE 43 28 160 A1 is produced from the sleeve prefabricated by hot isostatic pressing and from the screw flight front layer produced by hot isostatic pressing, a considerable material volume of high-alloy and wear-resistant and/or corrosion-resistant materials is required while resulting in a considerable amount of effort required for post-processing the blank to form the finished screw element. Compared to the production method according to the invention, the prior art method requires an additional production step since the sleeve is prefabricated by hot isostatic pressing. Furthermore, a considerable material volume of the wear-resistant and/or corrosion-resistant materials needs to be removed by machining, which makes post-processing more elaborate. Moreover, when the screw element produced by machining is subjected to subsequent heat treatment, care must be taken to prevent stress cracks from forming in the anti-wear layer during heat treatment as a result of the greatly varying thickness of the anti-wear layer.

In the production method according to the invention, the contoured anti-wear layer of the treatment element blank is adapted to the outer contour of the treatment element, which simplifies post-processing since the material volume to be removed is significantly reduced and/or the anti-wear layer has a substantially constant radial thickness along the central longitudinal axis of the treatment element, allowing the formation of stress cracks during heat treatment to be prevented.

A method, in which the treatment element core is provided with a contour on a core outer side for producing the contoured annular space, provides a simple way of providing the anti-wear layer with a contour on an anti-wear layer inner side facing the treatment element core. This reduces the material volume required for the anti-wear layer and therefore the material quantity required for the second material. Furthermore, this ensures that the anti-wear layer has a substantially constant thickness along the central longitudinal axis which simplifies heat treatment.

A method, in which a core outer side has a radial distance from a central longitudinal axis of the treatment element core which radial distance varies along said central longitudinal axis, provides a simple way of forming a contoured annular gap along the central longitudinal axis or in a sectional plane extending through the central longitudinal axis. The radial distance between the outside of the core and the central longitudinal axis varies between a minimum distance and a maximum distance.

A method, in which a capsule wall inner side of the capsule wall is cylindrical, provides a simple way of forming a contoured annular space along the central longitudinal axis or in a sectional plane extending through the central longitudinal axis. The constant radial distance between the capsule wall inner side and the central longitudinal axis and the varying radial distance of the treatment element core from the central longitudinal axis result in a contoured annular space which has a thickness that varies along the central longitudinal axis. The thickness varies between a minimum thickness and a maximum thickness.

A method, in which the treatment element blank is formed by machining in such a way that a treatment element outer contour is produced, allows an anti-wear layer to be produced that has a substantially constant thickness along the central longitudinal axis. After the removal of material, the radial distance of the anti-wear layer outer side varies along the central longitudinal axis between a minimum radial distance and a maximum radial distance.

A method, in which a capsule wall inner side of the capsule wall is provided with a contour for producing the contoured annular space, provides a simple way of forming a contoured anti-wear layer outer side facing the capsule wall. On the one hand, this reduces the material volume required for the anti-wear layer. On the other hand, this greatly simplifies post-processing since the outer contour of the treatment element blank or of the treatment element is already produced by hot isostatic pressing. If necessary, the outer contour needs to be fine machined.

A method, in which a capsule wall inner side of the capsule wall has a varying radial distance from the central longitudinal axis, ensures that the anti-wear layer outer side facing the capsule wall is provided with a contour along the central longitudinal axis or in a sectional plane extending through the central longitudinal axis.

A method, in which the treatment element blank is produced in such a way as to be provided with a treatment element outer contour and that an anti-wear layer outer side only requires fine machining during post-processing, ensures a simple production of the treatment element.

A method, in which a core outer side of the treatment element core has a constant radial distance from a central longitudinal axis along said central longitudinal axis, ensures a simple provision of the treatment element core.

A method, in which, in order to produce the contoured annular space, a capsule wall inner side of the capsule wall and a core outer side of the treatment element core are provided with a contour, allows an anti-wear layer to be produced which is provided with a contour both on the anti-wear layer inner side and on the anti-wear layer outer side. As a result, the material volume required is on the one hand greatly reduced, allowing the anti-wear layer to be produced from a low material quantity of the second material. On the other hand, post-processing is extremely simplified since the outer contour of the treatment element blank or of the treatment element is already produced during hot isostatic pressing. Moreover, the anti-wear layer has a substantially constant radial thickness along the central longitudinal axis which simplifies heat treatment and prevents the formation of stress cracks.

A method, in which a capsule wall inner side and a capsule wall outer side of the capsule wall are provided with a contour, provides a simple way of forming and removing the capsule.

A method, in which a capsule bottom and a capsule cover are provided with through-openings which are arranged concentrically to each other for producing a treatment element blank having a through-hole, allows a treatment element blank to be produced with a through-hole.

Another object of the invention is to provide a treatment element blank which provides a simple way of producing a treatment element for a screw machine.

This object is achieved by a treatment element blank, in which the anti-wear layer is provided with a contour along a central longitudinal axis. Since the anti-wear layer is provided with a contour, the production of a treatment element from the treatment element blank is greatly simplified. The treatment element blank is the composite body produced directly by hot isostatic pressing without any further post-processing. The contoured anti-wear layer simplifies machining of the treatment element blank to form the outer contour and/or heat treatment of the treatment element after formation of the outer contour. The anti-wear layer is contoured along the central longitudinal axis or in a sectional plane extending through the central longitudinal axis. The other advantages of the treatment element blank according to the invention are the same as those of the method according to the invention already described above.

Furthermore, the advantages of the treatment element blank, in which a core outer side of the treatment element core facing the anti-wear layer is provided with a contour, in which a core outer side has a radial distance from a central longitudinal axis of the treatment element core that varies along the central longitudinal axis, in which the treatment element blank has a cylindrical blank outer side, in which an anti-wear layer outer side of the anti-wear layer facing away from the treatment element core is provided with a contour, in which a core outer side of the treatment element core facing the anti-wear layer and an anti-wear layer outer side of the anti-wear layer facing away from the treatment element core are provided with a contour, and/or in which the anti-wear layer has a radial distance from the central longitudinal axis that varies along the central longitudinal axis, correspond to the advantages of the inventive method already described above.

A treatment element blank, in which the treatment element core is tubular, provides a simple way of producing and configuring different screw machines. The inner side of the treatment element core is provided with an inner profile in the usual manner, allowing differently designed treatment elements to be arranged on a profiled shaft which can be configured in a variable manner.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is an axial sectional view through a capsule of a hot isostatic pressing installation during the production of a treatment element blank according to a first exemplary embodiment;

FIG. 2 is an axial sectional view through the treatment element blank in FIG. 1 and a treatment element produced from the treatment element blank;

FIG. 3 is an axial sectional view through a capsule of a hot isostatic pressing installation during the production of a treatment element blank according to a second exemplary embodiment;

FIG. 4 is an axial sectional view through the treatment element blank in FIG. 3 and a treatment element produced from the treatment element blank;

FIG. 5 is an axial sectional view through a capsule of a hot isostatic pressing installation during the production of a treatment element blank according to a third embodiment;

FIG. 6 is an axial sectional view through the treatment element blank in FIG. 5 and a treatment element produced from the treatment element blank;

FIG. 7 is an axial sectional view through a capsule of a hot isostatic pressing installation during the production of a treatment element blank according to a fourth exemplary embodiment;

FIG. 8 is an axial sectional view through a capsule of a hot isostatic pressing installation during the production of a treatment element blank according to a fifth exemplary embodiment;

FIG. 9 is an axial sectional view through a capsule of a hot isostatic pressing installation during the production of a treatment element blank according to a sixth exemplary embodiment; and

FIG. 10 is an axial sectional view through the treatment element blank in FIG. 9 and a treatment element produced from the treatment element blank.

### DESCRIPTION OF THE PREFERRED EMBODIMENTS

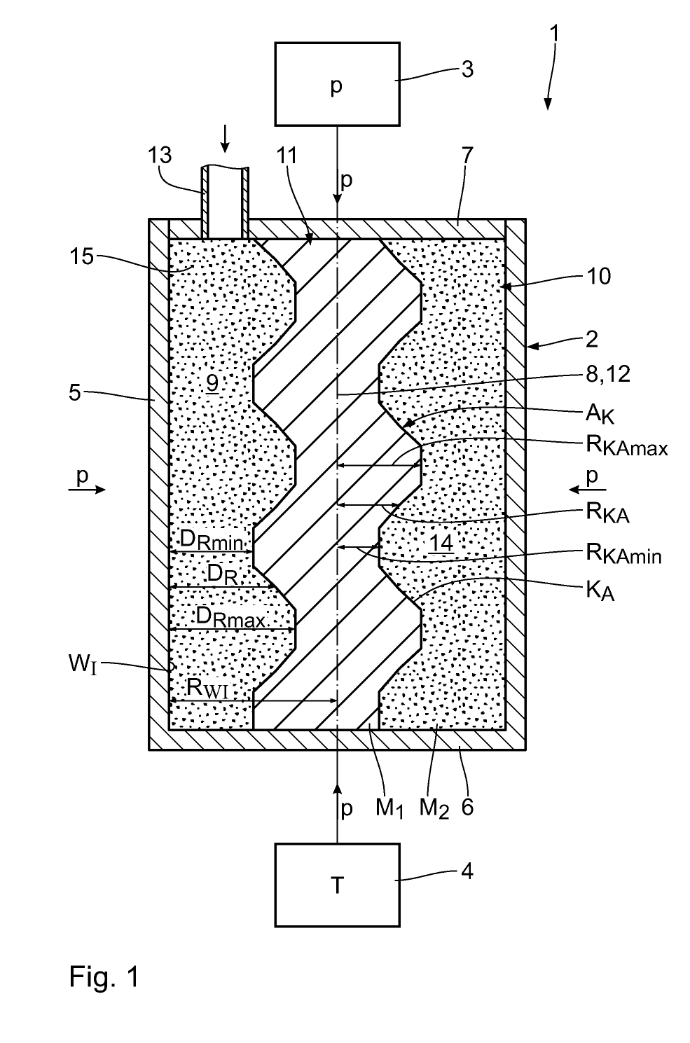

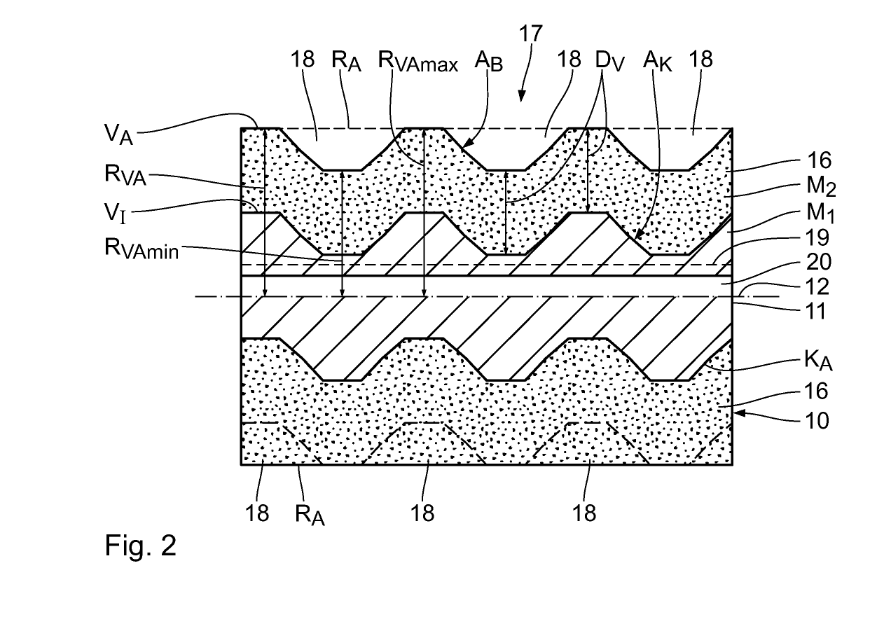

The following is a description of a first exemplary embodiment of the invention which is illustrated in FIGS. 1 and 2. A hot isostatic pressing installation 1 the structure of which is generally known comprises a capsule 2 which interacts with a pressure unit 3 and a temperature unit 4 for hot isostatic pressing. The capsule 2 has a tubular capsule wall 5 a first end of which is closed by a capsule bottom 6. A capsule cover 7 is arranged on a second end of the capsule wall 5. The capsule wall 5 defines a central longitudinal axis 8 and interacts with the capsule bottom 6 and the capsule cover 7 to define an inner space 9 of the capsule 2. Near the capsule wall 5, the capsule cover 7 is provided with a filler neck 13 for filling the inner space 9. For hot isostatic pressing, the temperature T in the inner space 9 is variable by means of the temperature unit 4, and the pressure p in the inner space 9 is variable by means of the pressure unit 3.

Production of a treatment element blank 10 in the pressing installation 1 is performed as follows:

In a first step, a treatment element core 11 of a first metal material M₁ is arranged in the inner space 9 in such a way that the central longitudinal axis 12 thereof is substantially congruent with the central longitudinal axis 8. The front side of the treatment element core 11 abuts against the capsule bottom 6. The first material M₁ shows a high degree of viscosity and ductility. Preferably, the first material M₁ is steel. Afterwards, the capsule cover 7 is arranged on the capsule wall 5 and welded thereto. The front side of the capsule cover 7 abuts against the treatment element core 11.

The treatment element core 11 has a core outer side K_{A} facing the annular space 14. The core outer side K_{A} is contoured so as to form a core outer contour A_{K}. Due to the core outer contour A_{K}, the core outer side K_{A} has a varying radial distance R_{KA} from and along the central longitudinal axis 8 or 12, wherein said radial distance R_{KA} varies between a minimum distance R_{KAmin} and a maximum distance R_{KAmax}.

The capsule wall 5 has a cylindrical capsule wall inner side W₁, with the result that the capsule wall inner side W₁ has a constant radial distance R_{W1} from the central longitudinal axis 8 or 12. Due to the constant radial distance R_{W1} and the varying distance R_{KA} of the treatment element core 11, the annular space 14 is provided with a contour, having a thickness D_{R} that varies along the central longitudinal axis 8 or 12, respectively, between a minimum thickness D_{Rmin} and a maximum thickness D_{Rmax}. The annular space 14 is completely filled with a powder of a second metal material M₂ via the filler neck 13; afterwards, the filler neck 13 is closed. The powder 15 is required to form an anti-wear layer 16 surrounding the treatment element core 11. To this end, the second material M₂ is a high-alloy material and therefore provides a high degree of wear-resistance and/or corrosion-resistance.

Afterwards, the treatment element blank 10 is produced in the pressing installation 1 by hot isostatic pressing so as to form a composite body of the first material M₁ and the second material M₂.

After hot isostatic pressing, the capsule 2 is removed by machining Due to the constant distance R_{W1}, the treatment element blank 10 has a non-contoured cylindrical blank outer side R_{A}. Correspondingly, the anti-wear layer 16 of the treatment element blank 10 has a constant radial distance R_{V} from the central longitudinal axis 12 which corresponds to the distance R_{W1}.

In a next step, the treatment element blank 10 is processed to form a treatment element 17. To this end, the treatment element blank 10 is formed by machining in such a way that a treatment element outer contour A_{B} is produced. To this end, material areas 18 of the anti-wear layer 16 of the treatment element blank 10 are removed. The treatment element 17 is thus formed by said removal of material. The treatment element outer contour A_{B} is formed by the anti-wear layer outer side V_{A}. After the removal of material, the radial distance R_{VA} varies along the central longitudinal axis 12 between a minimum distance R_{VAmin} and a maximum distance R_{VAmax}. Since both the core outer side K_{A}, which corresponds to the anti-wear layer inner side V₁, as well as the anti-wear layer outer side V_{A} are provided with a contour, the anti-wear layer 16 of the treatment element 17 has a substantially constant thickness D_{V} along the central longitudinal axis 12. Furthermore, an axial through-hole 20 is produced that is provided with an inner profile 19 for a profiled shaft. The through-hole 20 is preferably concentric to the central longitudinal axis 12. The blank outer side R_{A} of the treatment element blank 10 is shown below the central longitudinal axis 12 in FIG. 2 while the finished treatment element 17 is shown above the central longitudinal axis 12 in FIG. 2.

Since the annular space 14 has a radial distance R_{KA} that varies along the central longitudinal axis 12 because of the contoured core outer side K_{A}, the anti-wear layer inner side V₁ is provided with a contour as well, with the result that the quantity of the second material M₂ required for the formation of the anti-wear layer 16 is comparatively reduced. After the removal of material, the anti-wear layer 16 also has a constant thickness D_{V} in the material areas 18 which simplifies the subsequent heat treatment of the treatment element 14 while preventing the formation of stress cracks.

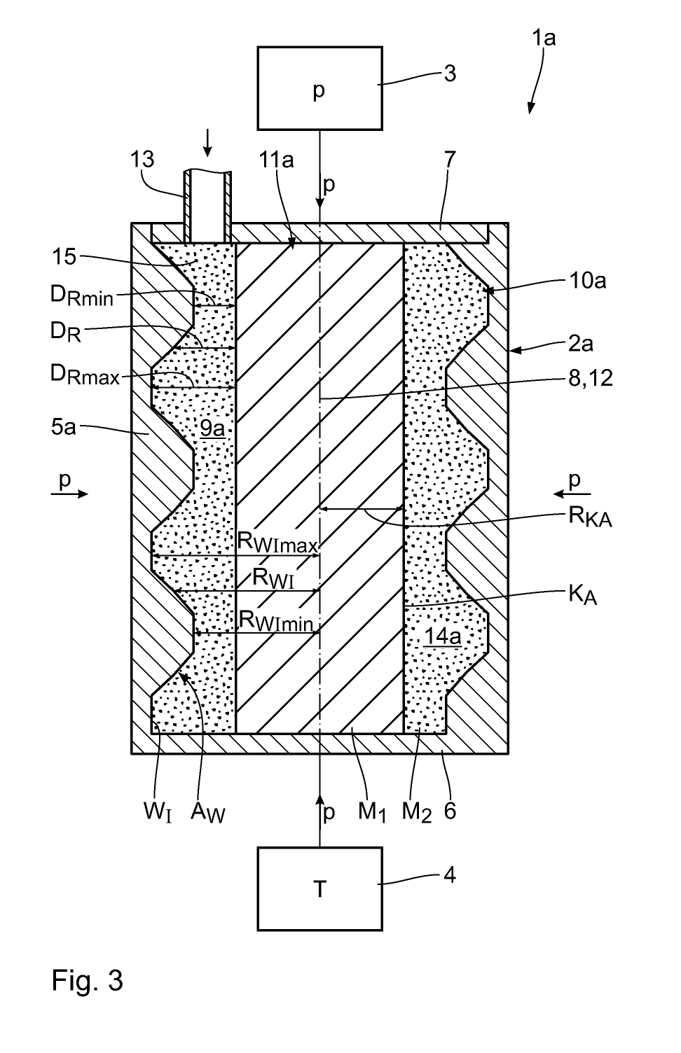

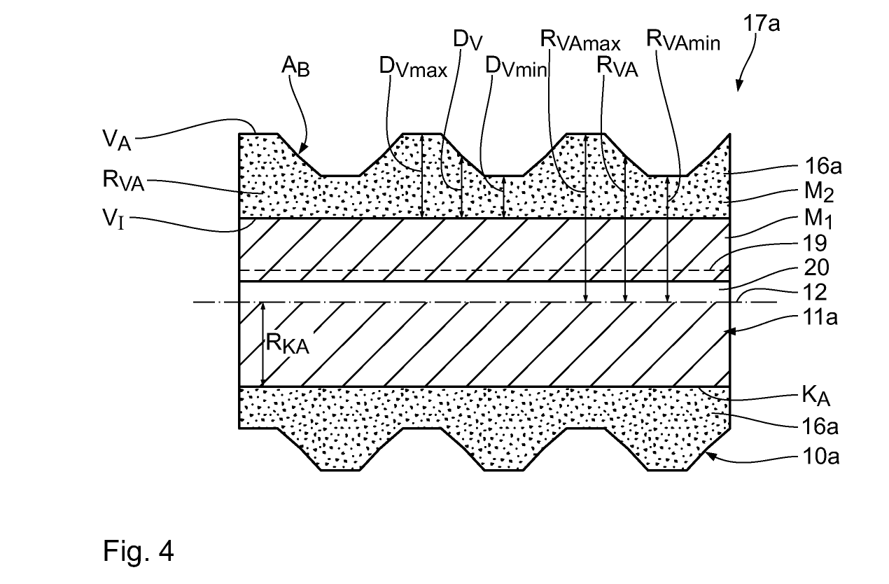

The following is a description of a second exemplary embodiment of the invention which is illustrated in FIGS. 3 and 4. In contrast to the first embodiment, the treatment element core 11a does not have a core outer contour A_{K}. Therefore, the core outer side K_{A} has a constant radial distance R_{KA} from the central longitudinal axis 12 along said central longitudinal axis 12. In order to form a contoured annular space 14a, the capsule wall inner side W₁ of the capsule wall 5a has a capsule wall outer contour A_{W}. To this end, the capsule wall 5a is configured as a tube the capsule wall inner side W₁ of which was machined to form the capsule wall outer contour A_{W}. Correspondingly, the capsule wall inner side W₁ has a radial distance R_{W1} from the central longitudinal axis 8 that varies between a minimum distance R_{W1min} and a maximum distance R_{W1max}. As a result, the radial thickness D_{R} of the annular space 14a varies along the central longitudinal axis 8 between a minimum radial thickness D_{Rmin} and a maximum radial thickness D_{Rmax} as well.

The treatment element blank 10a is produced in the manner already described above by arranging the treatment element core 11a in the capsule 2a of the pressing installation 1a and filling the annular space 14a with the powder 15. The treatment element blank 10a is produced by hot isostatic pressing. After hot isostatic pressing, the capsule 2a is removed by machining Since the capsule wall 5a is provided with a contour, the treatment element outer contour A_{B} is already formed during the production of the treatment element blank 10a. Corresponding to the radial thickness D_{R} of the annular space 14a, the radial thickness D_{V} of the anti-wear layer 16 varies along the central longitudinal axis 12 between a minimum radial thickness D_{Vmin} and a maximum radial thickness D_{Vmax}. The treatment element blank 10a is already provided with a contoured anti-wear layer outer side V_{A}. In order to produce the treatment element 17a, the anti-wear layer outer side V_{A} only requires a small amount of fine machining

Afterwards, the treatment element 17a is provided with the through-hole 20 and the inner profile 19 for the profiled shaft in the usual manner and subjected to a heat treatment. The finished treatment element 17 is again shown at the top of FIG. 4 while the treatment element blank 10a is shown at the bottom of FIG. 4. Details concerning the further production and structure of the treatment element blank 10a and of the treatment element 17a are set out in the description of the first exemplary embodiment.

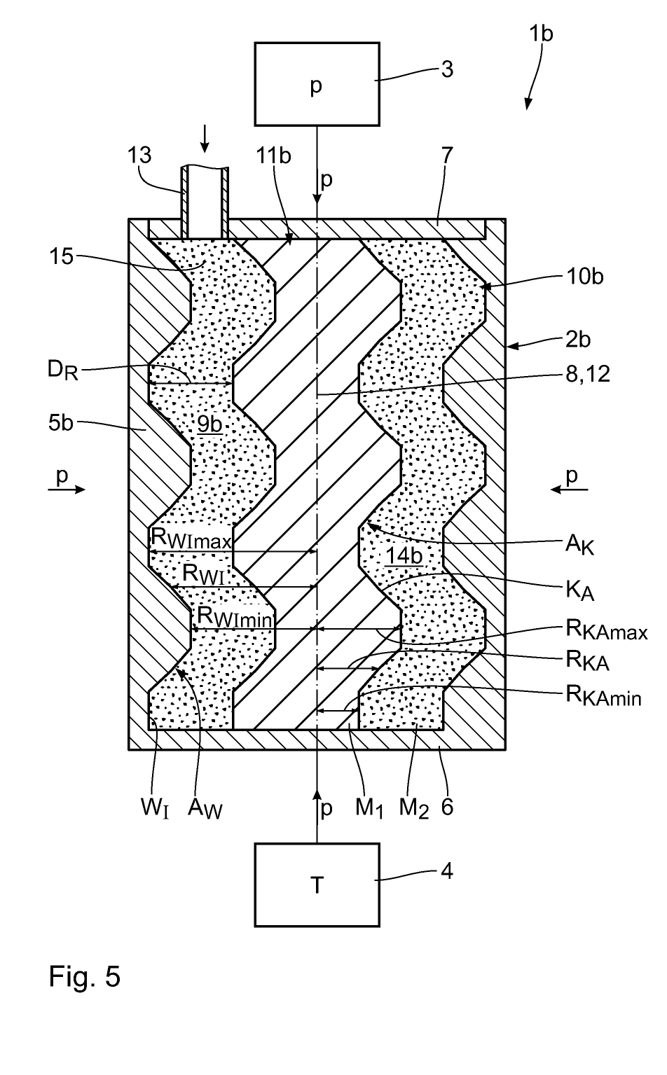

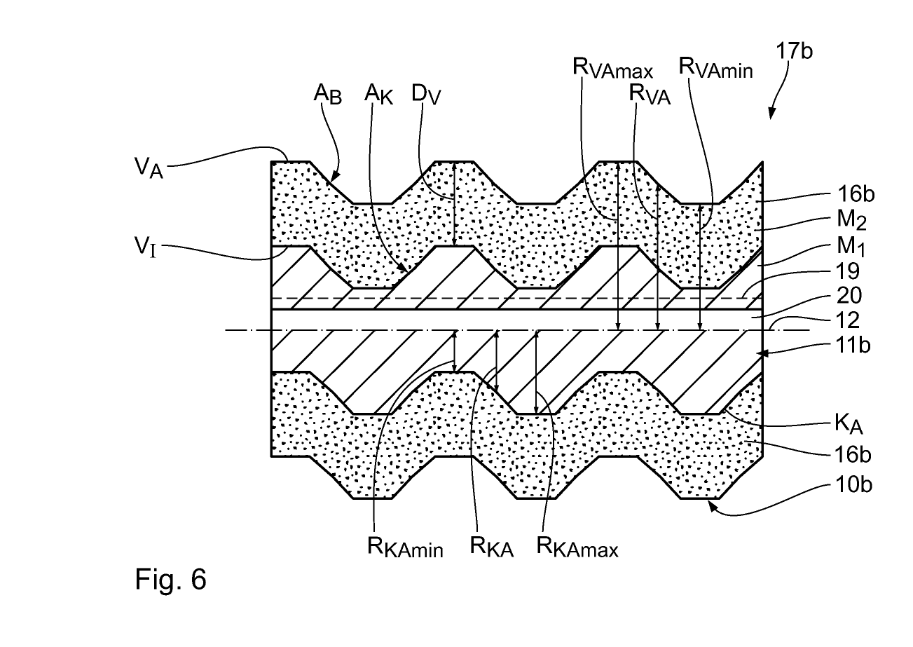

The following is a description of a third exemplary embodiment of the invention which is illustrated in FIGS. 5 and 6. The pressing installation 1b is designed corresponding to the second exemplary embodiment and comprises a capsule 2b having a contoured capsule wall inner side W₁. A treatment element core 11b corresponding to the first exemplary embodiment is arranged in the capsule 2b in such a way that an annular space 14b is formed which is provided with a contour along the central longitudinal axis 8 or 12, respectively. Since the core outer contour A_{K} substantially corresponds to the capsule wall outer contour A_{W}, the annular space 14b has a radial thickness D_{R} which is substantially constant along the central longitudinal axis 8 or 12, respectively. The annular space 14b is completely filled with the powder 15 in the manner described above, allowing the treatment element blank 10b to be produced by hot isostatic pressing after which the capsule 2b is removed in the manner described above.

The capsule wall outer contour A_{W} ensures that the treatment element blank 10 is already provided with the treatment element outer contour A_{B} during production. If necessary, the treatment element outer contour A_{B} is subjected to fine machining The core outer contour A_{K}, which substantially corresponds to the treatment element outer contour A_{B}, ensures that the anti-wear layer 16b thus formed has a radial thickness D_{V} which is substantially constant. The constant thickness D_{V} substantially prevents the formation of stress cracks, with the result that heat treatment of the treatment element 17b is simplified. The finished treatment element 17b is again shown at the top of FIG. 6 while the treatment element blank 10b is shown at the bottom of FIG. 6. Details concerning the further production and structure of the treatment element blank 10b and of the treatment element 17b are set out in the descriptions of the preceding exemplary embodiments.

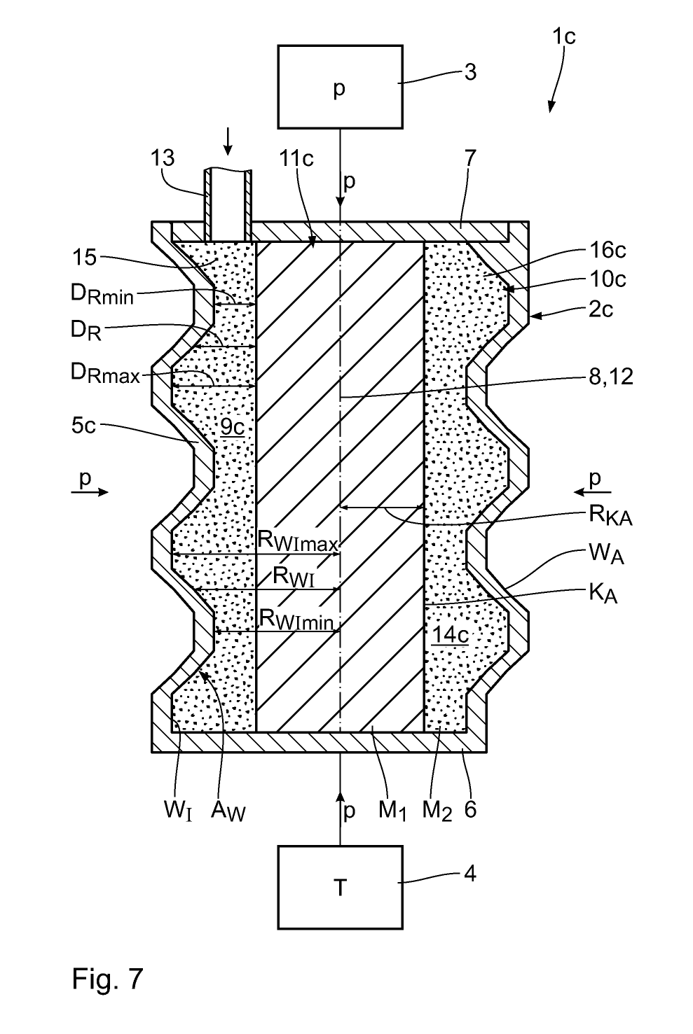

The following is a description of a fourth exemplary embodiment of the invention which is illustrated in FIG. 7. In contrast to the second embodiment, the capsule 2c is in the form of a profiled metal plate, having a capsule wall outer side W_{A} the contour of which corresponds to that of the capsule wall inner side W₁. The produced treatment element blank 10c and the produced treatment element 17c correspond to the treatment element blank 10a and the treatment element 17a, respectively. Details concerning the further production and structure of the treatment element blank 10c and of the treatment element 17c are set out in the descriptions of the preceding exemplary embodiments. Details concerning the structure and functioning of the pressing installation 1c are in particular set out in the description of the second exemplary embodiment.

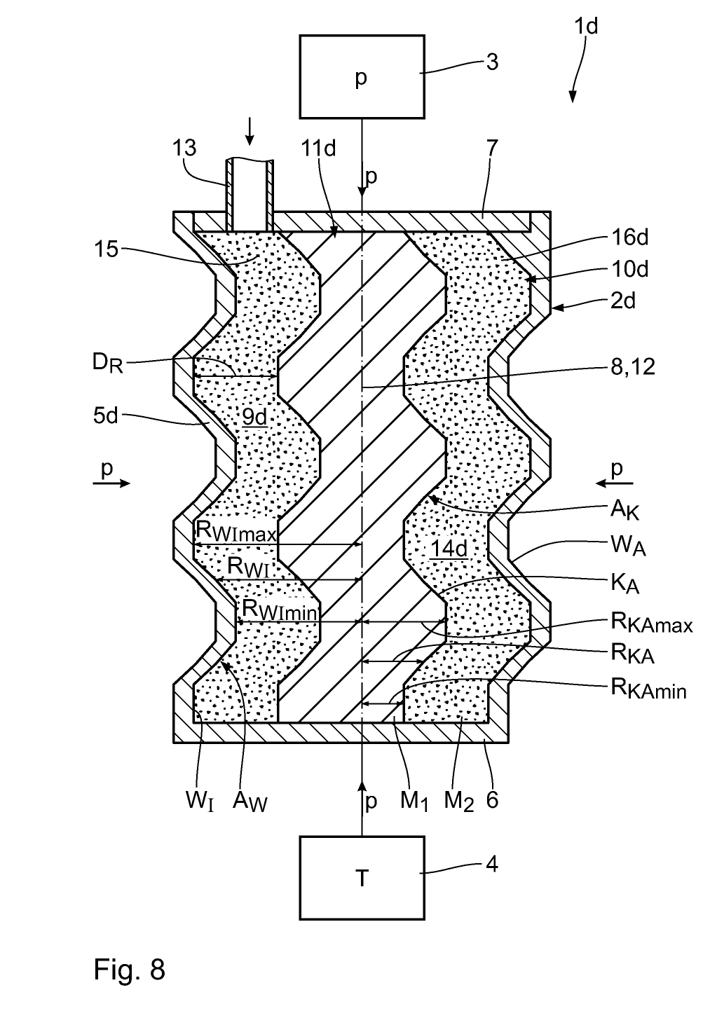

The following is a description of a fifth exemplary embodiment of the invention which is illustrated in FIG. 8. In contrast to the third embodiment, the capsule 2d is in the form of a profiled metal plate, having a capsule wall outer side W_{A} the contour of which corresponds to that of the capsule wall inner side W₁. The produced treatment element blank 10d and the produced treatment element 17d correspond to the treatment element blank 10b and the treatment element 17b, respectively. Details concerning the further production and structure of the treatment element blank 10d and of the treatment element 17d are set out in the descriptions of the preceding exemplary embodiments. Details concerning the structure and functioning of the pressing installation 1d are in particular set out in the description of the second exemplary embodiment.

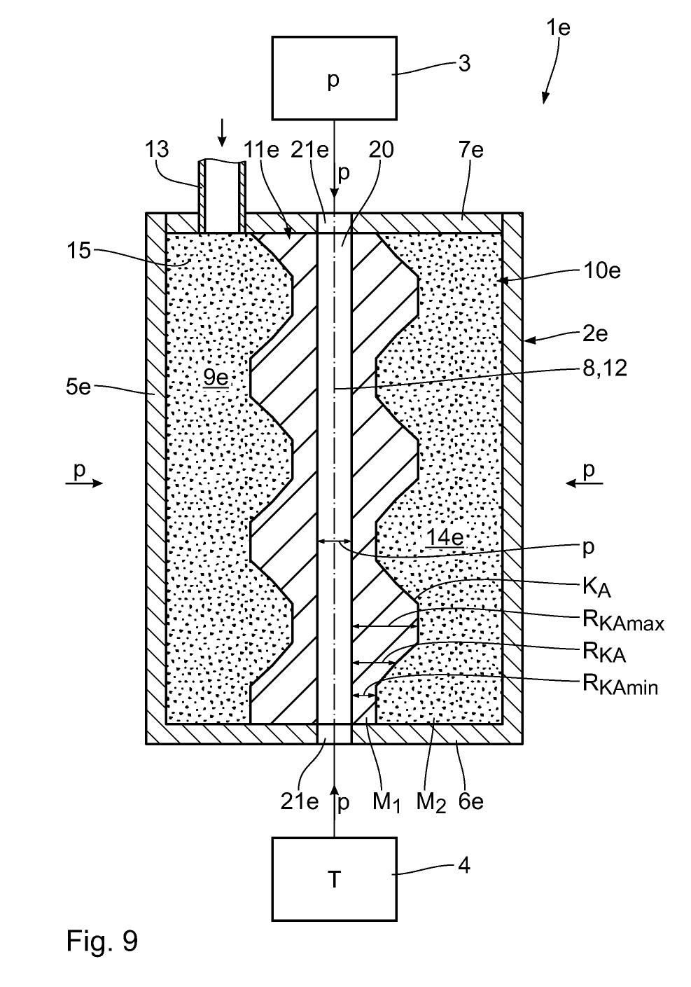

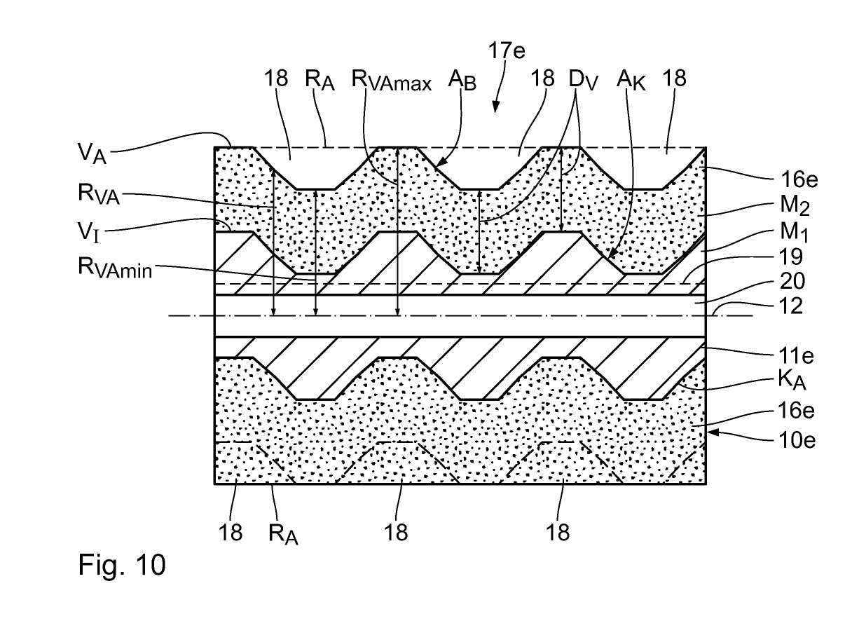

The following is a description of a sixth exemplary embodiment of the invention which is illustrated in FIGS. 9 and 10. In contrast to the first exemplary embodiment, the treatment element blank 10e is already produced in such a way as to be provided with the through-hole 20. To this end, each of the capsule bottom 6e and the capsule cover 7e of the pressing installation 1e is equipped with a through-opening 21e which through-openings 21e are arranged corresponding to the through-hole 20 of the treatment element core 11e. The treatment element core 11e is welded to the capsule bottom 6e and the capsule cover 7e so as to form the inner space 9e. The annular space 14e is filled with the powder 15 in the manner described above, allowing the composite body to be produced by hot isostatic pressing. The pressure p, which is applied to the through-hole 20 as well, prevents a deformation of the treatment element core 11e. Having removed the capsule 2e, the treatment element blank 10e is machined corresponding to the first exemplary embodiment, the only difference being that the through-hole 20 needs to be provided with the inner profile 19. Details concerning the further production and structure of the treatment element blank 10e and of the treatment element 17e are set out in the descriptions of the preceding exemplary embodiments.

Corresponding to the sixth exemplary embodiment, the treatment element blanks 10a to 10d may be provided with the through-hole 20 during production already if the capsules 2a to 2d of the pressing installations 1a to 1d are configured corresponding to the capsule 2e and are provided with through-openings which correspond to the through-openings 21e.

The treatment elements 17, 17a to 17e and the corresponding treatment element blanks 10, 10a to 10e are in particular configured as screw and/or kneading elements and intended for use in screw machines, in particular twin-shaft screw machines for the treatment and processing of plastic materials. Materials suitable for the second material M₂ are in particular those that allow a high degree of wear resistance and/or corrosion-resistance to be achieved. A suitable first material M₁ is in particular a high-viscosity, ductile material such as steel. The production method according to the invention reduces the material quantity required for the second material M₂. Heat treatment of the treatment elements 17, 17b, 17d, 17e is simplified since the anti-wear layer 16, 16b, 16d, 16e has a substantially constant radial thickness D_{V} along the central longitudinal axis 12. Moreover, post-machining of the treatment elements 17a, 17b, 17c, 17d is simplified since the treatment element blank 10a, 10b, 10c, 10d is already produced in such a way as to be equipped with the treatment element outer contour A_{B}. Generally speaking, the method according to the invention allows the production of treatment elements 17, 17a to 17e to be greatly simplified.

While specific embodiments of the invention have been shown and described in detail to illustrate the application of the principles of the invention, it will be understood that the invention may be embodied otherwise without departing from such principles.

1. A method for the production of a treatment element for a screw machine, the method comprising the following steps:
providing a capsule having a central longitudinal axis and a capsule wall defining an inner space;
arranging a treatment element core of a first metal material in the inner space in such a way that an annular space is formed between the capsule wall and the treatment element core and the annular space is provided with a contour along the central longitudinal axis;
filling the annular space with a powder of a second metal material so as to form an anti-wear layer;
producing a treatment element blank in such a way that a composite body is produced from the materials by hot isostatic pressing; and
post-processing the treatment element blank to obtain the treatment element.

2. A method according to claim 1, wherein the treatment element core is provided with a contour on a core outer side for producing the contoured annular space.

3. A method according to claim 1, wherein a core outer side has a radial distance from a central longitudinal axis of the treatment element core which radial distance varies along said central longitudinal axis.

4. A method according to claim 1, wherein a capsule wall inner side of the capsule wall is cylindrical.

5. A method according to claim 4, wherein the treatment element blank is formed by machining in such a way that a treatment element outer contour is produced.

6. A method according to claim 1, wherein a capsule wall inner side of the capsule wall is provided with a contour for producing the contoured annular space.

7. A method according to claim 1, wherein a capsule wall inner side of the capsule wall has a varying radial distance from the central longitudinal axis.

8. A method according to claim 6, wherein the treatment element blank is produced in such a way as to be provided with a treatment element outer contour and an anti-wear layer outer side only requires fine machining during post-processing.

9. A method according to claim 6, wherein a core outer side of the treatment element core has a constant radial distance from said central longitudinal axis along said central longitudinal axis.

10. A method according to claim 1, wherein in order to produce the contoured annular space, a capsule wall inner side of the capsule wall and a core outer side of the treatment element core are provided with a contour.

11. A method according to claim 1, wherein a capsule wall inner side and a capsule wall outer side of the capsule wall are provided with a contour.

12. A method according to claim 1, wherein a capsule bottom and a capsule cover are provided with through-openings which are arranged concentrically to each other for producing the treatment element blank having a through-hole.

13. A treatment element blank for the production of a treatment element for a screw machine, the treatment element blank comprising:
a treatment element core of a first metal material;
an anti-wear layer of a second metal material surrounding the treatment element core, wherein the second material is combined with the first material by hot isostatic pressing to form a composite body, wherein the anti-wear layer is provided with a contour along a central longitudinal axis.

14. A treatment element blank according to claim 13, wherein a core outer side of the treatment element core facing the anti-wear layer is provided with a contour.

15. A treatment element blank according to claim 13, wherein a core outer side has a radial distance from a central longitudinal axis of the treatment element core that varies along the central longitudinal axis.

16. A treatment element blank according to claim 13, wherein the treatment element blank has a cylindrical blank outer side.

17. A treatment element blank according to claim 13, wherein an anti-wear layer outer side of the anti-wear layer facing away from the treatment element core is provided with a contour.

18. A treatment element blank according to claim 13, wherein a core outer side of the treatment element core facing the anti-wear layer and an anti-wear layer outer side of the anti-wear layer facing away from the treatment element core are provided with a contour.

19. A treatment element blank according to claim 17, wherein the anti-wear layer has a radial distance from the central longitudinal axis that varies along the central longitudinal axis.

20. A treatment element blank according to claim 13, wherein the treatment element core is tubular.
